(19) United States
(12) Patent Application Publication
(10) Pub. No.: US 2026/0342540 A1
(43) Pub. Date: Oct. 29, 2026

(54) COMMUNICATION SYSTEM, FUNCTION EXECUTING DEVICE, AND NON-TRANSITORY COMPUTER-READABLE STORAGE MEDIUM STORING COMPUTER-READABLE INSTRUCTIONS FOR FUNCTION EXECUTING DEVICE

(71) Applicant: BROTHER KOGYO KABUSHIKI KAISHA, Nagoya (JP)

(72) Inventor: Hiroshi Shibata, Yatomi (JP)

(21) Appl. No.: 19/549,152

(22) Filed: Feb. 25, 2026

(30) Foreign Application Priority Data
Feb. 28, 2025 (JP) 2025-031040

(51) Int. Cl. H04L 9/08; G06F 3/12; H04W 84/12

(52) U.S. Cl. CPC H04L 9/0819; G06F 3/1222; G06F 3/1238; H04L 9/0894; G06F 3/1292; H04W 84/12

(57) ABSTRACT

A communication system including a function executing device and a terminal device is disclosed herein. In a case where an error occurs in the function executing device, the function executing device sends encryption information to the terminal device by a Wi-Fi network to which both of the terminal device and the function executing device belong. The encryption information is sent to the terminal device by communication using a layer that is a data link layer of an OSI reference model or lower but not using a layer that is a network layer of the OSI reference model or higher, and the encryption information is obtained by encrypting error information indicating the error by using key information. The terminal device receives the encryption information from the function executing device by using the Wi-Fi network and displays the error information obtained by decrypting the encryption information with the key information.

### REFERENCE TO RELATED APPLICATIONS

This application claims priority from Japanese Patent Application No. 2025-031040 filed on Feb. 28, 2025. The entire content of the priority application is incorporated herein by reference.

### BACKGROUND ART

A communication system including a communication device, a terminal device, and an access point is known. In this communication system, when communication via the access point is impossible between the communication and the terminal device, Bluetooth, Wi-Fi Aware, Near Field Communication (NFC) for example are used to establish a P2P connection such as Wi-Fi Direct. Bluetooth is a registered trademark of Bluetooth SIG. Wi-Fi Direct is a registered trademark of Wi-Fi Alliance.

### SUMMARY

The present teachings provide novel art configured to notify an error occurring in a function executing device securely.

A communication system is disclosed herein. The communication system may include a function executing device; and a terminal device. The function executing device may include a device interface configured for wireless communication according to a Wi-Fi standard. The function executing device may include a device memory configured to store key information for encrypting and decrypting information. The function executing device may include a device controller configured to, in a case where an error occurs in the function executing device, send encryption information to the terminal device via the device interface by using a Wi-Fi network to which both of the terminal device and the function executing device belong, wherein the encryption information is sent to the terminal device by using the Wi-Fi network and by using communication which uses a layer that is equal to or lower than a data link layer of an OSI reference model but does not use a layer that is equal to or higher than a network layer of the OSI reference model, and wherein the encryption information is obtained by encrypting error information indicating the error by using the key information. The terminal device may include a terminal interface configured for wireless communication according to the Wi-Fi standard. The terminal device may include a terminal memory configured to store the key information. The terminal device may include a terminal display unit. The terminal device may include a terminal controller. The terminal controller may be configured to receive the encryption information from the function executing device via the terminal interface by using the Wi-Fi network. The terminal controller may be configured to, in a case where the encryption information is received from the function executing device, cause the terminal display unit to display the error information that is obtained by decrypting the encryption information by using the key information.

According to the above configuration, the function executing device sends the encryption information to the terminal device by using the Wi-Fi network in the case where an error occurs. Here, the encryption information is sent to the terminal device without using a layer that is equal to or higher than the network layer of the OSI reference model but by using a layer that is equal to or lower than the data link layer of the OSI reference model. The encryption information is information obtained by encrypting the error information indicating the error by using the key information. As a result of this, the error information obtained by decrypting the encryption information by using the key information is displayed on the terminal device. As such, the function executing device can notify the error that has occurred in the function executing device by using the communication which uses a layer that is equal to or lower than the data link layer. In particular, since the function executing device executes the communication of the encryption information in which the error information is encrypted, the function executing device can notify the error securely.

A function executing device is also disclosed herein. The function executing device may include a device interface configured for wireless communication according to a Wi-Fi standard. The function executing device may include a device memory configured to store key information for encrypting and decrypting information. The function executing device may include a device controller configured to, in a case where an error occurs in the function executing device, send encryption information to a terminal device via the device interface by using a Wi-Fi network to which both of the terminal device and the function executing device belong, wherein the encryption information is sent to the terminal device by using the Wi-Fi network and by using communication which uses a layer that is equal to or lower than a data link layer of an OSI reference model but does not use a layer that is equal to or higher than a network layer of the OSI reference model, and wherein the encryption information is obtained by encrypting error information indicating the error by using the key information.

The function executing device can notify the error that has occurred in the function executing device by using the communication which uses a layer that is equal to or lower than the data link layer. In particular, since the function executing device executes the communication of the encryption information in which the error information is encrypted, the function executing device can notify the error securely.

A non-transitory computer-readable storage medium storing computer-readable instructions for the above-described function executing device and a method executed by the function executing device are also novel and useful. Here, the above-mentioned storage medium may be one medium or plural media.

### BRIEF DESCRIPTION OF DRAWINGS

FIG. 1 is a configuration diagram of a communication system.

FIG. 2 is a sequence diagram of processes executed between devices.

FIG. 3 is a sequence diagram of Case A.

FIG. 4 is a sequence diagram of a communication process for specifying a distance.

FIG. 5 is a sequence diagram of Case B.

### DESCRIPTION

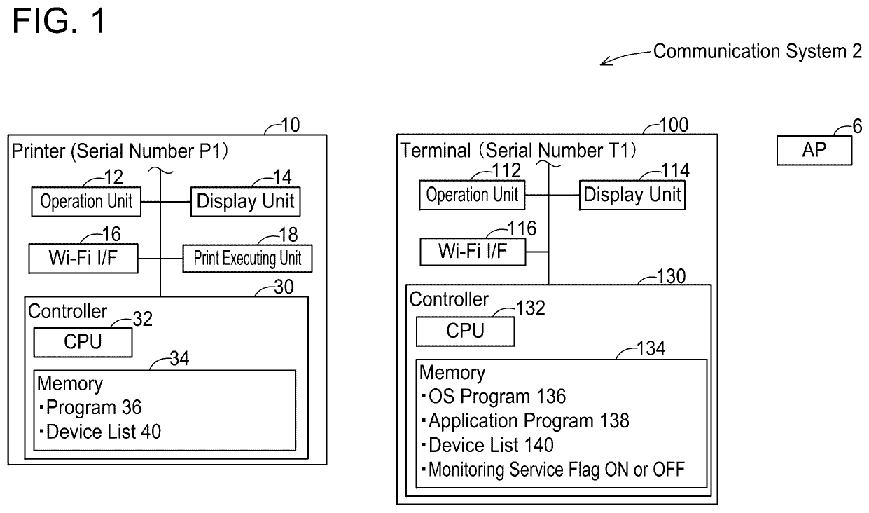

### Configuration of Communication System 2; FIG. 1

As illustrated in FIG. 1, a communication system 2 comprises a printer 10, a terminal 100, and an access point (hereafter, “AP”) 6. The printer 10 and the terminal 100 belong to the same Neighbor Awareness Networking (NAN) cluster. The NAN cluster is a wireless network defined by Wi-Fi Aware of a Wi-Fi standard. Further, the printer 10 and the terminal 100 belong to a wireless network formed by the AP 6. The terminal 100 can send print data representing an image to be printed to the printer 10 through the AP 6. The present embodiment discloses art configured to, when an error occurs in the printer 10, cause the terminal 100 to display information regarding that error.

### Configuration of Printer 10

The printer 10 is a peripheral device configured to execute a print function, and is, for example, a peripheral device for the terminal 100. In a modification, the printer 10 may be a multifunction peripheral configured to execute a scan function and a facsimile function for example, in addition to the print function. The printer 10 comprises an operation unit 12, a display unit 14, a Wi-Fi interface 16, a print executing unit 18, and a controller 30. The respective units 12 to 30 are connected to a bus line. Hereafter, an interface will be termed “I/F”.

The operation unit 12 is a user interface configured to allow the user to input various information to the printer 10. The operation unit 12 comprises, for example, a touch screen for displaying software key(s) (operational object(s)), hardware key(s), or both. The hardware key(s) include, for example, button(s) and/or switch(es). The display unit 14 is a display or a panel for displaying various information. The panel may be a touch panel (touch screen) or may not be a touch panel. Further, the panel is for example a liquid crystal panel or an organic EL panel. The print executing unit 18 comprises an inkjet print engine, an electrophotographic print engine, or a thermal print engine.

The Wi-Fi I/F 16 is a wireless I/F for Wi-Fi communication according to the Wi-Fi standard. The Wi-Fi standard is a wireless communication standard for wireless communication according to, for example, 802.11 standard of the Institute of Electrical and Electronics Engineers, Inc. (IEEE) and standards in compliance therewith such as 802.11a, 11b, 11n, and 11ac. Especially, the Wi-Fi I/F 16 supports the Wi-Fi Aware scheme established by the Wi-Fi Alliance. The Wi-Fi Aware scheme is described in detail in the specification called “Wi-Fi Aware Specification Version 4.0” created by the Wi-Fi Alliance. Wi-Fi Aware is also called Wi-Fi Neighbor Awareness Networking (NAN).

The devices 10 and 100 can join a NAN cluster of the Wi-Fi Aware scheme, although details will be described later. Among devices within the same NAN cluster, their Discovery Windows are synchronized. Here, a Discovery Window is a period during which signals are communicated. Communication which uses the NAN cluster is communication which does not use a layer that is equal to or higher than a network layer of an OSI reference model but uses a layer that is equal to or lower than a data link layer of the OSI reference model.

The devices within the NAN cluster play any one of roles called Master, Anchor Master, and Non-Master. A Master is capable of sharing timer information, searching for services, and inviting a device to the NAN cluster. In addition to the Master's functions, an Anchor Master is also capable of setting timer information for synchronization. A Non-Master is capable of sharing timer information and searching for services but incapable of inviting a device to the cluster.

Each device within the NAN cluster can search for other devices within the NAN cluster (more specifically, services provided by the other devices). A signal for searching for a service is called ‘Subscribe’. A device that has received a Subscribe sends a response signal called ‘Publish’. In the present embodiment, the printer 10 sends a Subscribe for searching for another device which can provide a monitoring service of monitoring the status of a device. Specifically, when an error occurs in the printer 10, the printer 10 sends such Subscribe. In the present embodiment, the terminal 100 can provide the above-mentioned monitoring service. Due to this, when the terminal 100 receives the Subscribe from the printer 10, the terminal 100 sends the Publish indicating that the terminal 100 can provide the monitoring service to the printer 10.

Also, the Wi-Fi I/F 16 is configured to execute wireless communication according to a normal Wi-Fi scheme different from the Wi-Fi Aware scheme. In general terms, the wireless communication according to the normal Wi-Fi scheme is wireless communication which uses an AP, whereas the wireless communication according to the Wi-Fi Aware scheme is wireless communication which does not use an AP. For example, the printer 10 can join a normal Wi-Fi network by establishing a wireless connection with an AP. Hereafter, the wireless connection with the AP may be termed “AP connection”. The printer 10 can execute wireless communication with another device belonging to the normal Wi-Fi network through the AP 6.

The controller 30 comprises a CPU 32 and a memory 34. The memory 34 comprises a main storage and an auxiliary storage. Although this is an example, the main storage comprises, for example, a RAM and cache memory. Although this is an example, the auxiliary storage may be, for example, a ROM, a flash memory, a Solid State Drive (SSD), a Hard Disk Drive (HDD) or a combination thereof. A program 36 and a device list 40 are stored in the auxiliary storage of the memory 34. The CPU 32 executes respective processes in accordance with the program 36 loaded from the auxiliary storage to the main storage.

The device list 40 is a list which stores device(s) that can provide the monitoring service. In the device list 40, the serial number of the device and a shared key which is shared with the device are stored in association with each other. Although details will be described later, the shared key is information used for encryption of error information and decryption of the encrypted information.

### Configuration of Terminal 100

The terminal 100 is a mobile terminal device such as a mobile phone, a smartphone, a PDA, a tablet PC, or the like. In a modification, the terminal 100 may be a stationary PC, a laptop PC, or the like. The terminal 100 is assigned a serial number T1 for identifying the terminal 100. The terminal 100 can provide the monitoring service. The terminal 100 comprises an operation unit 112, a display unit 114, a Wi-Fi I/F 116, and a controller 130. The units 112 to 130 are connected to a bus line.

The operation unit 112 is an I/F configured to allow the user to input various information to the terminal 100. The operation unit 112 comprises, for example, a touch screen for displaying software key(s) (operational object(s)), hardware key(s), or both. The hardware key(s) include, for example, button(s) and/or switch(es). The display unit 114 is a display or a panel for displaying various information. The panel may be a touch panel or may not be a touch panel. Further, the panel is for example a liquid crystal panel or an organic EL panel. The Wi-Fi I/F 116 is the same as the Wi-Fi I/F 16 of the printer 10. That is, the Wi-Fi I/F 116 supports the Wi-Fi Aware scheme and is also configured to execute wireless communication according to the normal Wi-Fi scheme.

The controller 130 comprises a CPU 132 and a memory 134. The memory 134 comprises a main storage and an auxiliary storage. Although this is an example, the main storage comprises for example a RAM, a cache memory, etc. Although this is an example, the auxiliary storage may be, for example, a ROM, a flash memory, a SSD, a HDD, or any combination thereof. An OS program 136, an application program 138, a device list 140, and a monitoring service flag are stored in the auxiliary storage of the memory 134. The CPU 132 implements various processes according to the programs 136, 138 loaded from the auxiliary storage to the main storage. Hereinafter, an OS program is abbreviated as “OS” and the application program is abbreviated as “app”.

The OS 136 controls basic operations of the terminal 100. The app 138 can cause the OS 136 to execute a process according to the Wi-Fi Aware scheme so that the terminal 100 joins the NAN cluster. The app 138 can execute various communication with another device belonging to the NAN cluster by using the NAN cluster. Also, the app 138 can send print data representing an image to be printed to the printer 10 through the AP. Also, the app 138 realizes provision of the monitoring service. The app 138 is downloaded, for example, from a server on the internet and installed in the terminal 100.

The device list 140 is a list which stores device(s) that are target(s) for monitoring in the monitoring service which is provided by the app 138. The device list 140 is installed in the terminal 100 along with the app 138. In the device list 140, a serial number of a monitoring target device and a shared key shared with that device are stored in association with each other.

The monitoring service flag is a flag owned by the app 138, and indicates either “ON” indicating that the monitoring service is in the middle of being provided or “OFF” indicating that the monitoring service is not in the middle of being provided. Specifically, the state where the monitoring service flag indicates “ON” is a state of sending the Publish in response to receiving the Subscribe which searches for the monitoring service. Contrary to this, the state where the monitoring service flag indicates “OFF” is a state of not sending the Publish in response to receiving the above-mentioned Subscribe. The monitoring service flag can be designated by a user.

### Configuration of AP 6

The AP 6 is a normal access point called a wireless access point or a wireless LAN router. The AP 6 relays communication between devices belonging to a wireless network in which the AP 6 operates as a parent station.

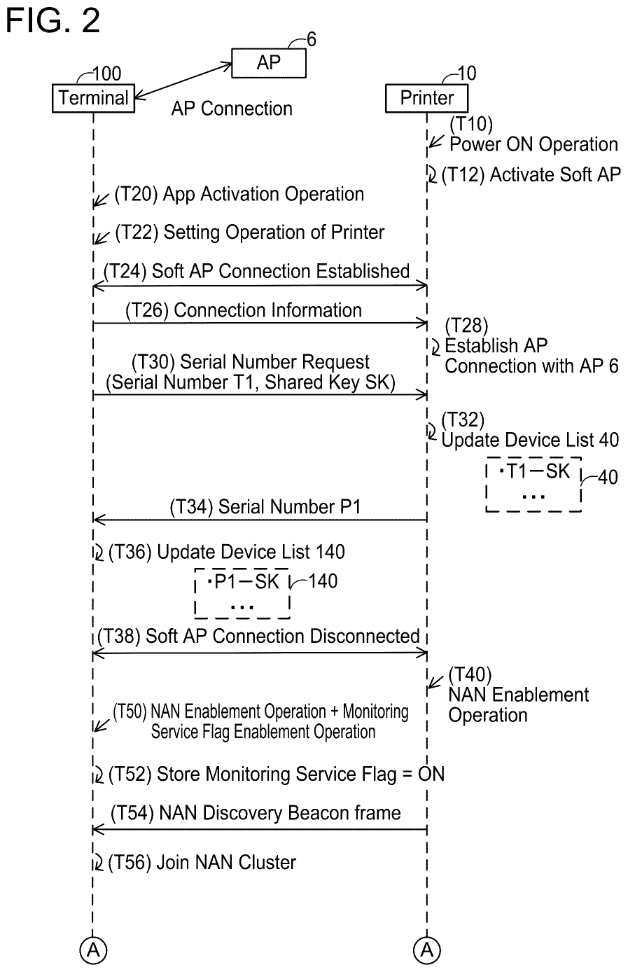

### Processes Executed Between Devices; FIG. 2

Subsequently, with reference to FIG. 2, processes executed between devices will be described. Hereafter, as to the processes executed by the CPU (e.g., 32, 132) of each device (e.g., the printer 10, the terminal 100), for easier understanding, those will be described with each device described as a subject of action, without the CPU described as the subject of action. Also, communication between the devices will be executed via a Wi-Fi I/F (e.g., 16, 116). Accordingly, in the following description, communication will be described without describing “through the Wi-Fi I/F”.

In an initial state of FIG. 2, an AP connection is already established (i.e., already present) between the terminal 100 and the AP 6. That is, the terminal 100 has already stored connection information for establishing the AP connection with the AP 6, therein. The connection information is a combination of a Service Set Identifier (SSID) and a password. Further, in the initial state of FIG. 2, the monitoring service flag indicates “OFF”. In such state, the printer 10 is newly installed.

The newly installed printer 10 receives a power ON operation from a user in T10. In this case, the printer 10 activates SoftAP, and forms a wireless network in T12. The SoftAP is activated for initial settings of the printer 10. The SSID of the wireless network formed by the activation of this SoftAP may for example include a serial number P1 of the printer 10. Hereafter, the wireless connection using SoftAP will be termed “SoftAP connection”.

The terminal 100 receives an app activation operation for activating the app 138 from the user in T20. The app activation operation is an operation of selecting an app icon included in a home screen of the OS 136. In this case, the app 138 of the terminal 100 displays the home screen of the app 138 on the display unit 114. Such home screen includes a Print button for causing the printer to print and a Setting button for initial settings of the printer, for example.

The terminal 100 receives selection of the Setting button in the home screen in T22. In this case, the terminal 100 displays an SSID selection screen on the display unit 114. Such SSID selection screen includes SSID(s) of wireless network(s) existing around the terminal 100. Then, the terminal 100 receives selection of the SSID including the serial number P1 of the printer 10 and input of a password on the SSID selection screen. Here, the password is shown on, for example, an instruction manual of the printer 10. As a result of this, the several processes for establishing the SoftAP connection between the printer 10 and the terminal 100 are executed, by which the SoftAP connection is established between the printer 10 and the terminal 100 in T24. The above-mentioned several processes include authentication of the SSID and password, for example.

The terminal 100 uses the SoftAP connection to send the connection information of the AP 6 to the printer 10 in T26.

The printer 10 uses the SoftAP connection to receive the connection information of the AP 6 from the terminal 100 in T26. In this case, the several processes for establishing the AP connection between the printer 10 and the AP 6 are executed, by which the AP connection is established between the printer 10 and the AP 6 in T28. The above-mentioned several processes include authentication of the connection information, for example.

As described above, the app 138 of the terminal 100 in the present embodiment can provide the monitoring service. When the SoftAP connection is established between the terminal 100 and the printer 10, the terminal 100 executes the following processes in accordance with the app 138. That is, the terminal 100 uses the SoftAP connection to send a serial number request to the printer 10 in T30. The serial number request is a signal which requests the printer 10 to send a serial number and includes a serial number T1 of the terminal 100 and a shared key SK. Here, the shared key SK may be created by the terminal 100 in response to the operation of T24 being performed or may be pre-stored in the memory 134. In particular, in the former case, each time the operation of T24 is performed, a different shared key may be created. In the present embodiment, the former case will be described as an example. In the present embodiment, regardless of whether the monitoring service flag indicates “ON” or “OFF”, the process of T30 is executed. In a modification, the process of T30 may executed only when the monitoring service flag indicates “ON”.

The printer 10 uses the SoftAP connection to receive the serial number request from the terminal 100 in T30. In this case, the printer 10 updates the device list 40 in T32. Specifically, the printer 10 stores the serial number T1 included in the serial number request and the shared key SK included in the serial number request in association with each other in the device list 40. Then, the printer 10 uses the SoftAP connection to send the serial number P1 of the printer 10 to the terminal 100 in T34.

The terminal 100 uses the SoftAP connection to receive the serial number P1 from the printer 10 in T34. In this case, the terminal 100 updates the device list 140 in T36. Specifically, the terminal 100 stores the received serial number P1 and the created shared key SK, in association with each other in the device list 140. Thereafter, the SoftAP connection between the printer 10 and the terminal 100 is disconnected in T38.

The printer 10 receives a NAN enablement operation from the user in T40. In this case, the printer 10 shifts from a NAN disabled state to a NAN enabled state. Here, the “NAN disabled state” means a state where the device cannot communicate signals according to the Wi-Fi Aware scheme. The “NAN enabled state” means a state where the device can communicate signals according to the Wi-Fi Aware scheme. When the printer 10 has shifted to the NAN enabled state, the printer 10 forms a NAN cluster. That is, the NAN cluster to which the printer 10 only belongs is formed in T40. In such NAN cluster, the printer 10 operates as an Anchor Master. In a modification, when the SoftAP connection between the printer 10 and the terminal 100 is disconnected in T38, the printer 10 may automatically shift from the NAN disabled state to the NAN enabled state without receiving the NAN enablement operation from the user.

The terminal 100 receives the NAN enablement operation from the user in T50. In this case, the terminal 100 shifts from the NAN disabled state to the NAN enabled state. When the terminal 100 has shifted to the NAN enabled state, the terminal 100 forms the NAN cluster. That is, the NAN cluster to which the terminal 100 only belongs is formed in T50. In such NAN cluster, the terminal 100 operates as an Anchor Master. As such, at the timing of T50, the NAN cluster to which the printer 10 only belongs and the NAN cluster to which the terminal 100 only belongs, respectively, exist. In a modification, the SoftAP connection between the terminal 100 and the printer 10 is disconnected in T38, the terminal 100 may automatically shift from the NAN disabled state to the NAN enabled state without receiving the NAN enablement operation from the user.

The terminal 100 receives a monitoring service enablement operation from the user in T50. The monitoring service enablement operation is an operation for changing the monitoring service flag from “OFF” to “ON”. The user can, for example, select the button for changing settings in the home screen of the app 138 and change the monitoring service flag from “OFF” to “ON”. In this case, the terminal 100 changes the monitoring service flag in the memory 134 from “OFF” to “ON” in T52. In a modification, the SoftAP connection between the terminal 100 and the printer 10 is disconnected in T38, the terminal 100 may automatically change the monitoring service flag from “OFF” to “ON” without receiving the monitoring service enablement operation from the user in T52.

The printer 10 sends a NAN Discovery Beacon frame by broadcasting in T54. Hereafter, such signal will be termed “Discovery” simply. The Discovery is a signal according to the Wi-Fi Aware scheme that advises information related to the NAN cluster to which the printer 10 belongs to external devices. Devices that do not belong to the NAN cluster can join the NAN cluster by receiving the Discovery. That is, the Discovery can be also construed as a signal for inviting devices that do not belong to the NAN cluster to the NAN cluster. The printer 10 periodically sends a Discovery while the printer 10 is in the NAN enabled state.

At the time of T54, the terminal 100 is in the NAN enabled state. Due to this, the terminal 100 receives the Discovery from the printer 10 in T54. In this case, the terminal 100 joins the NAN cluster to which the printer 10 belongs in T56. As a result of this, the printer 10 and the terminal 100 now belong to the same NAN cluster. In this case, the NAN cluster to which the terminal 100 only belonged, that is, the one which was formed in T50, disappears. At the time of T56, one NAN cluster to which both the printer 10 and the terminal 100 exists. Although not illustrated, when the terminal 100 joins the NAN cluster, the terminal 100 communicates with the printer 10 to determine its role in the NAN cluster. In the present case, the printer 10 operates as an Anchor Master and the terminal 100 operates as a Non-Master.

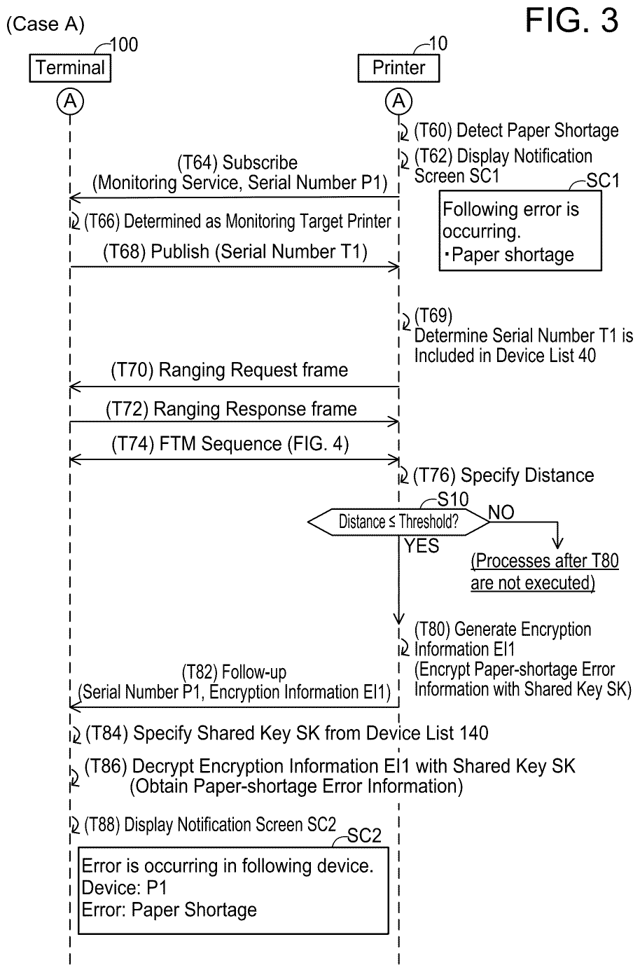

### Case A; FIG. 3

Subsequently, with reference to FIG. 3, Case A will be described. The process of T60 in FIG. 3 is a process continued from FIG. 2. In Case A, an error that print paper for printing images in a paper tray runs out in the printer 10. Hereafter, such error will be termed “paper shortage error”.

The printer 10 detects the paper shortage error in T60 in FIG. 3. That is, the printer 10 detects that print paper in the paper tray has run out in T60. In this case, the printer 10 displays a notification screen SC1 on the display unit 14 in T62. The notification screen SC1 is a screen for notifying the user that the paper shortage error has occurred. The user can recognize that the paper shortage error is occurring in the printer 10 by looking at the notification screen SC1.

The user may possibly, however, not see the display unit 14 of the printer 10 at a timing when the paper shortage error occurs in the printer 10. That is, the user may possibly not see the notification screen SC1 displayed in the printer 10 right away. Due to this, the printer 10 executes the following processes to notify the terminal 100 of paper shortage error information indicating that the paper shortage error has occurred.

When the printer 10 detects the paper shortage error, the printer 10 uses the NAN cluster to send a Subscribe for searching for the monitoring service in T64. Such Subscribe includes the serial number P1 of the printer 10.

The app 138 of the terminal 100 receives the Subscribe from the printer 10 in T64. In this case, the terminal 100 executes the following processes in accordance with the app 138. That is, the terminal 100 firstly determines whether the monitoring service flag in the memory 134 indicates “ON” or “OFF”. In the present case, the monitoring service flag indicates “ON” (T52 in FIG. 2). In this case, the terminal 100 determines whether the printer 10 which sent the Subscribe is a monitoring target or not. Specifically, the terminal 100 determines whether the serial number P1 included in the Subscribe is already stored in the device list 140 or not. In the present case, the serial number P1 is stored in the device list 140 (T36 in FIG. 2). Due to this, the terminal 100 determines that the printer 10 is the monitoring target in T66. In this case, the terminal 100 uses the NAN cluster to send a Publish to the printer 10 in T68. This Publish includes the serial number T1 of the terminal 100. Here, when the monitoring service flag indicates “OFF” or when the serial number P1 included in the Subscribe is not stored in the device list 140, the terminal 100 does not send the Publish to the printer 10. As such, the terminal 100 can send the Publish only when provision of the monitoring service is desired by the user. Also, the terminal 100 can send the Publish only when the printer 10 which sent the Subscribe is the monitoring target.

The printer 10 uses the NAN cluster to receive the Publish from the terminal 100 in T68. In this case, the printer 10 determines whether the serial number T1 included in the Publish is stored in the device list 40 or not. In the present case, the printer 10 determines that the serial number T1 is stored in the device list 40 in T69 (see T32 in FIG. 2). In this case, the printer 10 uses the NAN cluster to send a Ranging Request frame to the terminal 100 in T70. The Ranging Request frame is a signal which requests the printer 10 to execute a process of measuring the distance between the printer 10 and the terminal 100.

The terminal 100 uses the NAN cluster to receive the Ranging Request frame from the printer 10 in T70. In this case, the terminal 100 uses the NAN cluster to send a Ranging Response frame to the printer 10 in T72. In T70 and T72, information required for communication of T74 to be described later, e.g., parameter(s) for measurements, is communicated. That is, the communication of T70 and T72 is preparatory communication for the communication of T74.

The printer 10 receives the Ranging Response frame from the terminal 100 in T72. In this case, Fine Timing Measurement (FTM) Sequence is executed between the printer 10 and the terminal 100 in T74. The FTM is a distance calculation algorithm implemented in the Wi-Fi Aware scheme. In the FTM Sequence, the NAN cluster is used.

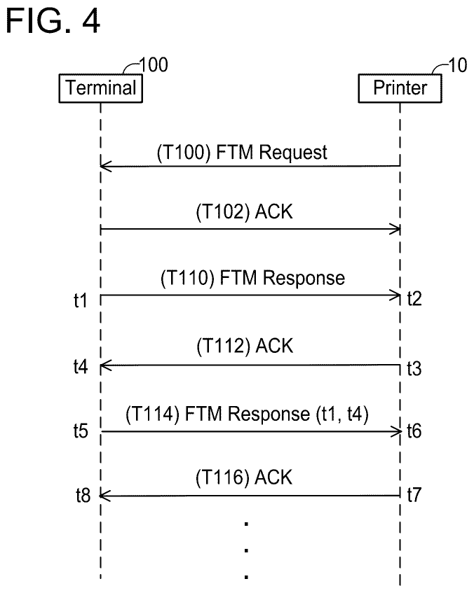

### FTM Sequence: FIG. 4

Referring now to FIG. 4, the FTM Sequence in T74 in FIG. 3 will be described. In T100, the printer 10 sends an FTM request to the terminal 100. The FTM request is a signal that requests the FTM to be started and includes, for example, information related to frequency bands used for various FTM communications.

In response to receiving the FTM request from the printer 10 in T100, the terminal 100 sends an ACK to the printer 10 in T102. In response, the FTM is started from T110.

In the FTM, the terminal 100 first sends an FTM response to the printer 10 in T110. At this time, the terminal 100 stores a time t1 at which the FTM response was sent.

The printer 10 receives the FTM response from the terminal 100 in T110. At this time, the printer 10 stores a time t2 at which the FTM response was received. The printer 10 then sends an ACK to the terminal 100 in T112. At this time, the printer 10 stores a time t3 at which the ACK was sent.

The terminal 100 receives the ACK from the printer 10 in T112. At this time, the terminal 100 stores a time t4 at which the ACK was received.

The terminal 100 then sends an FTM response to the printer 10 in T114. This FTM response includes the stored time t1 and time t4. Further, the terminal 100 stores a time t5 at which the FTM response was sent in T114.

The printer 10 receives the FTM response from the terminal 100 in T114. At this time, the printer 10 stores a time t6 at which the FTM response was received.

The printer 10 calculates the distance between the printer 10 and the terminal 100 by using the stored times t2 and t3 and the times t1 and t4 included in the FTM response received in T114. Specifically, the printer 10 first calculates RTT1=(t4−t1)−(t3−t2). The RTT1 is the sum of a time period taken to send the FTM response of T110 and a time period taken to send the ACK of T112. That is, the RTT1 is a time period taken for one cycle of communication between the printer 10 and the terminal 100. The printer 10 then calculates the distance between the printer 10 and the terminal 100 by a formula ((c×RTT1)/2), where c is light speed. Thus, the printer 10 can calculate the distance between the printer 10 and the terminal 100 using the times t1 and t2 related to the communication of the FTM response and the times t3 and t4 related to the communication of the ACK.

In T116, the printer 10 sends an ACK to the terminal 100. At this time, the printer 10 stores a time t7 at which the ACK was sent.

The terminal 100 receives the ACK from the printer 10 in T116. At this time, the terminal 100 stores a time t8 at which the ACK was received.

Thereafter, the printer 10 and the terminal 100 repeat communicating an FTM response and an ACK predetermined times. The printer 10 calculates a distance between the printer 10 and the terminal 100 for each cycle of communication of an FTM response and ACK. For example, for the FTM response of T114 and the ACK of T116, a distance between the printer 10 and the terminal 100 is calculated by a formula ((c×RTT2)/2), where RTT2=(t8−t5)−(t7−t6).

### Continuation of Processes: FIG. 3

Returning to the description of FIG. 3, in T76, the printer 10 specifies the distance between the printer 10 and the terminal 100 by calculating an average of the multiple distances calculated in the FTM Sequence in T74.

The printer 10 determines whether the distance specified in T76 is equal to or less than a predetermined threshold in S10. Here, the threshold is for example 10 m. However, 10 m is an example, and the threshold may be less than 10 m or more than 10 m. When the specified distance is equal to or less than the threshold (YES to S10), the printer 10 proceeds to T80. Contrary to this, when the specified distance is more than the threshold (NO to S10), the printer 10 does not execute the processes from T80.

The printer 10 encrypts the paper shortage error information to create encryption information EI1 in T80. Specifically, the printer 10 specifies the shared key SK associated with the serial number T1 included in the Publish which was received in T68, from the device list 40. Then, the printer 10 uses the specified shared key SK to encrypt the paper shortage error information and create the encryption information EI1. Thereafter, the printer 10 uses the NAN cluster to send a Follow-up to the terminal 100 in T82. The Follow-up is a signal according to the Wi-Fi Aware scheme. The Follow-up in T82 includes the serial number P1 of the printer 10 and the encryption information EI1.

The terminal 100 uses the NAN cluster to receive the Follow-up from the printer 10 in T82. In this case, the terminal 100 specifies the shared key SK associated with the serial number P1 included in the Follow-up from the device list 140 in T84. Then, the terminal 100 uses the specified shared key SK to decrypt the encryption information EI1 in T86. As mentioned above, in the present case, the same shared key SK is shared between the printer 10 and the terminal 100. Due to this, the terminal 100 can obtain the paper shortage error information by decrypting the encryption information EI1 in T86. That is, the terminal 100 can recognize that the paper shortage error is occurring in the printer 10 by communication using the NAN cluster.

When the terminal 100 obtains the paper shortage error information in T86, the terminal 100 displays a notification screen SC2 on the display unit 114 in T88. The notification screen SC2 includes information indicating that the paper shortage error is occurring in the printer 10 identified by the serial number P1 included in the Follow-up of T82. The user can acknowledge that the paper shortage error is occurring in the printer 10 by looking at the notification screen SC2. The user who looked at the notification screen SC2 can replenish the print paper in the paper tray of the printer 10.

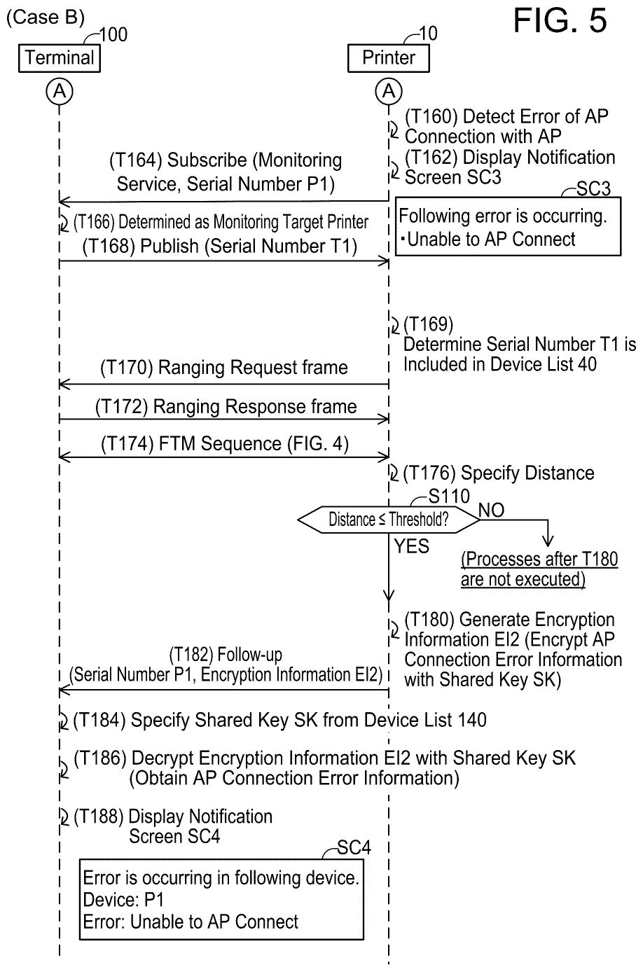

### Case B; FIG. 5

Next, with reference to FIG. 5, Case B will be described. The process of T160 in FIG. 5 is a process continued from FIG. 2. In Case B, in the printer 10, an error occurs in an AP connection with the AP 6 and then the AP connection with the AP 6 is disconnected. Hereafter, such error will be termed “AP connection error”. The AP connection error occurs for example when a new AP is installed to replace the AP 6 and the AP 6 is removed and/or when the connection information of the AP 6 is changed.

The printer 10 detects the AP connection error in T160 in FIG. 5. That is, the printer 10 detects that the AP connection with the AP 6 has been disconnected in T160. In this case, the printer 10 displays a notification screen SC3 on the display unit 14 in T162. The notification screen SC3 is a screen for notifying the user that the AP connection error has occurred. By looking at the notification screen SC3, the user can acknowledge that the AP connection error is occurring in the printer 10, that is, that the AP connection between the printer 10 and the AP 6 has been disconnected. In the present case also, the user might not see the notification screen SC3 displayed on the printer 10 right away. Due to this, the printer 10 executes the following processes to notify the terminal 100 of AP connection error information indicating that the AP connection error has occurred. The processes of T164 to T176 and the process of S110 are respectively the same as the processes of T64 to T74 and the process of S10 in FIG. 2.

The printer 10 encrypts the AP connection error information to create encryption information EI2 in T180. Specifically, the printer 10 specifies the shared key SK associated with the serial number T1 included in the Publish which was received in T168, from the device list 40. Then, the printer 10 uses the specified shared key SK to encrypt the AP connection error information and create the encryption information EI2. Thereafter, the printer 10 uses the NAN cluster to send a Follow-up to the terminal 100 in T182. Such Follow-up includes the serial number P1 of the printer 10 and the encryption information EI2.

The terminal 100 uses the NAN cluster to receive a Follow-up from the printer 10 in T182. In this case, the terminal 100 specifies the shared key SK associated with the serial number P1 included in the Follow-up from the device list 140 in T184. Then, the terminal 100 uses the specified shared key SK to decrypt the encryption information EI2 in T186. As mentioned above, in the present case, the same shared key SK is shared between the printer 10 and the terminal 100. Due to this, the terminal 100 can obtain the AP connection error information by decrypting the encryption information EI2 in T186. That is, the terminal 100 can recognize that the AP connection error is occurring in the printer 10 by communication using the NAN cluster.

When the terminal 100 obtains the AP connection error information in T186, the terminal 100 displays a notification screen SC4 on the display unit 114 in T188. The notification screen SC4 includes information indicating that the AP connection error is occurring in the printer 10 identified by the serial number P1 included in the Follow-up of T182. The user can acknowledge that the AP connection error is occurring in the printer 10 by looking at the notification screen SC4. The user who looked at the notification screen SC4 can perform an operation for causing the printer 10 to establish an AP connection. Such operation includes, for example, an operation of inputting connection information for the new AP and/or operation of inputting the connection information as changed.

### Effects of Embodiments

According to the above configuration, when an error such as the paper shortage error occurs, the printer 10 uses the NAN cluster to send the encryption information EI1 to the terminal 100 (T82 in FIG. 3). That is, the encryption information EI1 is sent to the terminal 100 without using a layer that is equal to or higher than a network layer of the OSI reference model but by using a layer that is equal to or lower than the data link layer of the OSI reference model. The encryption information EI1 is information obtained by encrypting the paper shortage error information with the shared key SK. As a result of this, the terminal 100 displays the notification screen SC2 including the paper shortage error information obtained by decrypting the encryption information EI1 with the shared key SK (T88). As such, the printer 10 can notify an error occurring in the printer 10 by using communication which uses a layer that is equal to or lower than the data link layer, that is, by using the NAN cluster. In particular, since the printer 10 communicates the encryption information EI1 in which the paper shortage error information is encrypted with the shared key SK, the printer 10 can notify an error securely.

When YES is determined to S10 in the printer 10, the terminal 100 displays the notification screen SC2. That is, the terminal 100 can display the notification screen SC2 only when the terminal 100 is positioned near the printer 10. As mentioned above, the user who looked at the notification screen SC2 needs to go near the printer 10 in order to replenish the print paper in the paper tray of the printer 10. If the notification screen SC2 is displayed on the terminal 100 which is far from the printer 10, the user who looked at the notification screen SC2 needs to bring oneself to the printer, which is located far away. In order not to impose such a heavy load on the user, in the present embodiment, a configuration is adopted in which the notification screen SC2 is not displayed on the terminal 100 located far away from the printer 10.

### Correspondence Relations

The printer 10 and the terminal 100 are respectively an example of “function executing device” and “terminal device”. The AP 6 is an example of “access point”. The serial number P1 of the printer 10 is an example of “identification information”. The display unit 14 and the display unit 114 are respectively an example of “device display unit” and “terminal display unit”. The Wi-Fi I/F 16 and the Wi-Fi I/F116 are respectively an example of “device interface” and “terminal interface”. The memory 34 and the memory 134 are respectively an example of “device memory” and “terminal memory”. The monitoring service flag is an example of “flag information”. In particular, the values “ON” and “OFF” of the monitoring service flag are respectively an example of “first value” and “second value”. The shared key SK is an example of “key information”. The NAN cluster is an example of “Wi-Fi network”. The encryption information EI1, EI2 is an example of “encryption information”. The Subscribe is an example of “predetermined signal”. The Publish is an example of “response signal”. The print paper is an example of “consumables”.

Correspondence relations of the processes executed by the “function executing device” are as follows. The process of T62 in FIG. 3 and the process of T162 in FIG. 5 are an example of “cause the device display unit to display the error information”. The process of T64 in FIG. 3 and the process of T164 in FIG. 5 are example of “send a predetermined signal”. The process of T68 in FIG. 3 and the process of T168 in FIG. 5 are example of “receive the response signal”. The processes of T70 to T76 in FIG. 3 and the processes of T170 to T176 in FIG. 5 are example of processes executed by “specify a distance between the terminal device and the function executing device”. The process of T82 in FIG. 3 and the process of T182 in FIG. 5 are example of “send encryption information”.

Correspondence relations of processes executed by the “terminal device” are as follows. The process of T64 in FIG. 3 and the process of T164 in FIG. 5 are example of “receive the predetermined signal”. The process of T68 in FIG. 3 and the process of T168 in FIG. 5 are example of “send a response signal”. The process of T82 in FIG. 3 and the process of T182 in FIG. 5 are example of “receive the encryption information”. The process of T88 in FIG. 3 and the process of T188 in FIG. 5 are example of “cause the terminal display unit to display the error information”.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:
(Modification 1) In the above embodiments, a situation where the paper shortage error occurs (Case A) and a situation where the AP connection error occurs (Case B) were described. The present art is advantageous in a situation where an error other than the errors described in the above embodiments occurs. For example, when ink for printing runs out, the printer 10 may execute the same processes as T64 to T76 and S10 in FIG. 3. Then, the printer 10 may use the NAN cluster to send encryption information obtained by encrypting error information indicating that the ink has run out to the terminal 100. In the present modification, the ink is an example of “consumables”. Also, in another modification, for example, when the printer 10 detects physical malfunction in the ink head of the print executing unit 18 for example, the printer 10 may execute the same processes as T64 to T76 and S10 in FIG. 3. Then, the printer 10 may use the NAN cluster to send encryption information obtained by encrypting error information indicating such physical malfunction to the terminal 100. Also, the printer 10 may for example comprise a scan executing unit configured to scan. Then, also when the printer 10 detects a physical malfunction in the scan executing unit, the printer 10 may use the NAN cluster to send encryption information obtained by encrypting the error information to the terminal 100. In general terms, the “error” may be any type of error as long as it occurs in the “function executing device”.
(Modification 2) The processes of T64 to T69 in FIG. 3 may be omitted. In this case, for example, the printer 10 may use the NAN cluster to send the encryption information EI1 to a device existing near the printer 10. If such device stores the shared key SK, the device can decrypt the encryption information EI1 and obtain the error information. In the present modification, “send a predetermined signal” and “receive the response signal” executed by the “function executing device” may be omitted. Also, in the present modification, “receive the predetermined signal” and “send a response signal” executed by the “terminal device” may be omitted.
(Modification 3) The terminal 100 may omit the process of T66 in FIG. 3. In this case, the Subscribe of T64 may not include the serial number P1 of the printer 10. Then, when the terminal 100 receives the Subscribe in T64, the terminal 100 may send the Publish to the printer 10 in T68.
(Modification 4) The memory 134 of the terminal 100 may not store the monitoring service flag. In this case, when the terminal 100 receives the Subscribe from the printer 10 in T64, the terminal 100 may execute the processes from T54 without determining whether the monitoring service flag in the memory 134 indicates “ON” or not. That is, the terminal 100 may be configured to provide the monitoring service at all times. In the present modification, the monitoring service enablement operation in T50 and the process of T52 in FIG. 2 may be omitted.
(Modification 5) The processes of T70 to T76 and the process of S10 in FIG. 3 may be omitted. In the present modification, “specify a distance between the terminal device and the function executing device” by the “function executing device” may be omitted.
(Modification 6) The printer 10 may omit the process of T62 in FIG. 3. In the present modification, “cause the device display unit to display the error information” by the “function executing device” may be omitted.
(Modification 7) In T64, the printer 10 may send a Publish indicating that the error has occurred, instead of the Subscribe which searches for the monitoring service. In this case, in T68, the terminal 100 having received the Publish may send a Follow-up instead of the Publish. In the present modification, the above-mentioned Publish and Follow-up are respectively an example of “predetermined signal” and “response signal”. Also, in T82, the printer 10 may use a signal different from the Follow-up to send the encryption information EI1. In another modification, the art described in the above embodiments, a scheme/method different from the Wi-Fi Aware scheme may be implemented. For example, the printer 10 may use a wireless network formed in accordance with the different scheme/method to send a signal including encryption information to the terminal 100. The signal may be sent by using communication which does not use a layer that is equal to or higher than the network layer of the OSI reference model but uses a layer that is equal to or lower than the data link layer of the OSI reference model.
(Modification 8) In the above embodiments, the process of each step shown in FIGS. 2 to 5 is implemented by software (e.g., the program 36, the OS 136, the app 138). However, at least one of these processes may alternatively be implemented by hardware such as a logic circuit.

What is claimed is

1. A communication system comprising:
a function executing device; and
a terminal device,
wherein the function executing device comprises:
a device interface configured for wireless communication according to a Wi-Fi standard;
a device memory configured to store key information for encrypting and decrypting information; and
a device controller configured to, in a case where an error occurs in the function executing device, send encryption information to the terminal device via the device interface by using a Wi-Fi network to which both of the terminal device and the function executing device belong, wherein the encryption information is sent to the terminal device by using the Wi-Fi network and by using communication which uses a layer that is equal to or lower than a data link layer of an OSI reference model but does not use a layer that is equal to or higher than a network layer of the OSI reference model, and wherein the encryption information is obtained by encrypting error information indicating the error by using the key information,
wherein the terminal device comprises:
a terminal interface configured for wireless communication according to the Wi-Fi standard;
a terminal memory configured to store the key information;
a terminal display unit; and
a terminal controller,
wherein the terminal controller is configured to:
receive the encryption information from the function executing device via the terminal interface by using the Wi-Fi network; and
in a case where the encryption information is received from the function executing device, cause the terminal display unit to display the error information that is obtained by decrypting the encryption information by using the key information.

2. The communication system as in claim 1,
wherein the device controller is further configured to:
in the case where the error occurs, send a predetermined signal to the terminal device via the device interface by using the Wi-Fi network,
wherein the terminal controller is further configured to:
receive the predetermined signal from the function executing device via the terminal interface by using the Wi-Fi network; and
in a case where the predetermined signal is received from the function executing device, send a response signal to the predetermined signal to the function executing device via the terminal interface by using the Wi-Fi network,
wherein the device controller is further configured to:
receive the response signal from the terminal device via the device interface by using the Wi-Fi network,
wherein in a case where the response signal is received from the terminal device, the device controller sends the encryption information to the terminal device.

3. The communication system as in claim 2,
wherein the predetermined signal includes identification information for identifying the function executing device,
wherein in a case where the predetermined signal has been received from the function executing device and the identification information is stored in the terminal memory, the terminal controller sends the response signal to the function executing device, and
in a case where the predetermined signal has been received from the function executing device and the identification information is not stored in the terminal memory, the terminal controller does not send the response signal to the function executing device.

4. The communication system as in claim 2,
wherein the terminal memory is further configured to store flag information indicating either a first value which indicates sending of the response signal or a second value which indicates not sending of the response signal,
wherein in a case where the predetermined signal has been received from the function executing device and the flag information indicates the first value, the terminal controller sends the response signal to the function executing device, and
in a case where the predetermined signal has been received from the function executing device and the flag information indicates the second value, the terminal controller does not send the response signal to the function executing device.

5. The communication system as in claim 2,
wherein the Wi-Fi network is a Neighbor Awareness Networking (NAN) cluster formed according to a Wi-Fi Aware scheme of the Wi-Fi standard,
the predetermined signal is a Subscribe defined in the Wi-Fi Aware scheme, and
the response signal is a Publish defined in the Wi-Fi Aware scheme.

6. The communication system as in claim 1,
wherein the device controller is further configured to specify a distance between the terminal device and the function executing device,
wherein in a case where the distance is equal to or less than a threshold, the device controller sends the encryption information to the terminal device, and
in a case where the distance is greater than the threshold, the device controller does not send the encryption information to the terminal device.

7. The communication system as in claim 1,
wherein the function executing device further comprises a device display unit, and
the device controller is further configured to, in a case where the error occurs, cause the device display unit to display the error information.

8. The communication system as in claim 1,
wherein the function executing device is configured to execute a printing function, and
the error includes shortage of consumables for realizing the printing function.

9. The communication system as in claim 1,
wherein the error includes being unable to execute a wireless communication with an access point via the device interface.

10. The communication system as in claim 1,
wherein the Wi-Fi network is a Neighbor Awareness Networking (NAN) cluster formed according to a Wi-Fi Aware scheme of the Wi-Fi standard.

11. The communication system as in claim 10,
wherein the encryption information is communicated by a Follow-up defined in the Wi-Fi Aware scheme.

12. A function executing device comprising:
a device interface configured for wireless communication according to a Wi-Fi standard;
a device memory configured to store key information for encrypting and decrypting information; and
a device controller configured to, in a case where an error occurs in the function executing device, send encryption information to a terminal device via the device interface by using a Wi-Fi network to which both of the terminal device and the function executing device belong, wherein the encryption information is sent to the terminal device by using the Wi-Fi network and by using communication which uses a layer that is equal to or lower than a data link layer of an OSI reference model but does not use a layer that is equal to or higher than a network layer of the OSI reference model, and wherein the encryption information is obtained by encrypting error information indicating the error by using the key information.

13. A non-transitory computer-readable storage medium storing computer-readable instructions for a function executing device,
wherein the function executing device comprises:
a device interface configured for wireless communication according to a Wi-Fi standard;
a device memory configured to store key information for encrypting and decrypting information; and
a processor,
wherein the computer-readable instructions, when executed by the processor, cause the function executing device to, in a case where an error occurs in the function executing device, send encryption information to a terminal device via the device interface by using a Wi-Fi network to which both of the terminal device and the function executing device belong, wherein the encryption information is sent to the terminal device by using the Wi-Fi network and by using communication which uses a layer that is equal to or lower than a data link layer of an OSI reference model but does not use a layer that is equal to or higher than a network layer of the OSI reference model, and wherein the encryption information is obtained by encrypting error information indicating the error by using the key information.
